(19) United States
(12) Patent Application Publication
(10) Pub. No.: US 2025/0019850 A1
(43) Pub. Date: Jan. 16, 2025

(54) COMPACT APPARATUS FOR PRODUCTION OF IRON METAL BY ELECTROLYSIS

(71) Applicant: ArcelorMittal, Luxembourg (LU)

(72) Inventor: Hervé LAVELAINE DE MAUBEUGE, Metz (FR)

(21) Appl. No.: 18/714,286

(22) PCT Filed: Dec. 15, 2021
(86) PCT No.: PCT/IB2021/061750

§ 371 Date: May 29, 2024

(51) Int. Cl. C25C 1/06; C25C 7/02

(52) U.S. Cl. CPC C25C 1/06; C25C 7/02

(57) ABSTRACT

An apparatus (1) for the production of iron metal through reduction of iron ore by an electrolysis reaction the apparatus including a casing (4) including successively a terminal anode plate (2) at a first end of the casing (4), such anode being connected to a source of electric power, at least one bipolar electrode (11) including successively a cathode plate (3), a metallic plate (12), a gas recovery part (8) and a gas permeable anode plate (2) and a terminal cathode plate (3) at the other end of said casing (4), such cathode being connected to the source of electric power.

The invention is related to an apparatus to produce iron metal from iron oxides by an electrolysis process.

### BACKGROUND

Steel can be currently produced at an industrial scale through two main manufacturing routes. Nowadays, the most commonly used production route consists in producing pig iron in a blast furnace, by use of a reducing agent, mainly coke, to reduce iron oxides. In this method, approx. 450 to 600 kg of coke is consumed per metric ton of pig iron; this method, both in the production of coke from coal in a coking plant and in the production of the pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (Hot Direct Reduced Iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces. Even if this second route emits less CO2 than the previous one it still releases some and rely moreover on carbon fossil fuels.

Current developments thus focus on methods allowing production of iron which release less or even no CO2 and which is carbon-neutral.

A known alternative method to produce steel from iron ores made of iron oxides is based on electrochemical techniques. In such techniques, iron is produced from iron oxide using an electrolyser unit comprising two electrodes—an anode and a cathode—connected to a source of electric power, an electrolyte circuit and an iron oxide entry into the electrolyser unit. The anode and cathode are constantly immersed in the circulating electrolyte in order to ensure good electrical conduction between said electrodes. The electrolytic reaction produces pure iron plates on the cathode and gaseous oxygen at the anode. Iron plates thus obtained may then be melted with other elements such as a carbon source and scrap in electric furnaces to produce steel.

### SUMMARY OF THE INVENTION

One of the problems of this electrolyser unit is the need of very large electrodes in order to ensure good productivity, which substantially increased costs.

An aim of the present invention is therefore to remedy the drawbacks of the prior art by providing an apparatus for electrochemical iron production with enhanced productivity, cost effective and with an improved compacity.

The invention is related to an apparatus for the production of iron metal through reduction of iron ore by an electrolysis reaction, said electrolysis reaction generating a gas, the apparatus comprising a casing including successively:
a terminal gas-permeable anode plate at a first end of said casing, such anode being connected to a source of electric power and a gas recovery part extending along the upper part of said plate,
at least one bipolar electrode comprising successively a cathode plate, a metallic plate, a gas recovery part and a gas-permeable anode plate,
a terminal cathode plate at the other end of said casing, such cathode being connected to said source of electric power,
a gap being maintained between said terminal anode plate and the cathode plate of said bipolar plate, such gap forming an electrolyte chamber,
a gap being maintained between said terminal cathode plate and the anode plate of said bipolar plate, such gap forming an electrolyte chamber,
   the casing being provided with means for circulating an electrolyte within said electrolyte chambers, with means to supply iron ore to said electrolyte chambers, and with a gas outlet in fluidic connection with said electrolyte chambers.

The apparatus may also include the following optional characteristics considered individually or according to all possible combination of techniques:
the casing comprises a plurality of bipolar electrodes extending successively between said terminal anode plate and said terminal cathode plate, a gap being maintained between each bipolar electrode to form an electrolyte chamber,
the terminal anode plate and the terminal cathode plate are part of bipolar electrodes,
the elements composing the bipolar electrodes are held together with connecting means,
the terminal cathode plate and the cathode plates included in said bipolar electrodes are made of graphite.

### BRIEF DESCRIPTION OF THE DRAWINGS

Other characteristics and advantages of the invention will be apparent in the below description, by way of indication and in no way limiting, and referring to the appended figures among which:

FIG. 1, which represents a longitudinal section view of an apparatus according to the invention,

FIG. 2, which represents a three-dimensional longitudinal cross section view of a bipolar electrode of the invention,

FIG. 3, which represents a bottom view of the bipolar electrode of FIG. 2.

### DETAILED DESCRIPTION

First, it is noted that on the figures, the same references designate the same elements regardless of the figure on which they feature and regardless of the shape of these elements. Similarly, should elements not be specifically referenced in one of the figures, their references may be easily found by referring to another figure.

It is also noted that the figures represent mainly one embodiment of the object of the invention but other embodiments which correspond to the definition of the invention may exist. Elements in the figures are illustration and may not have been drawn to scale.

The invention refers to an apparatus 1 provided for the production of iron metal (Fe) through the reduction of iron ore, containing notably hematite (Fe₂O₃) and other iron oxides or hydroxides, by an electrolysis reaction. Said chemical reaction is well known and described by the following equation (1):

$${Fe}_{2} {O}_{3} ↔ 2 Fe + \frac{3}{2} {O}_{2} \qquad ( 1 )$$

The electrolysis reaction thus generates gases—mainly oxygen—that have to be extracted from the apparatus 1.

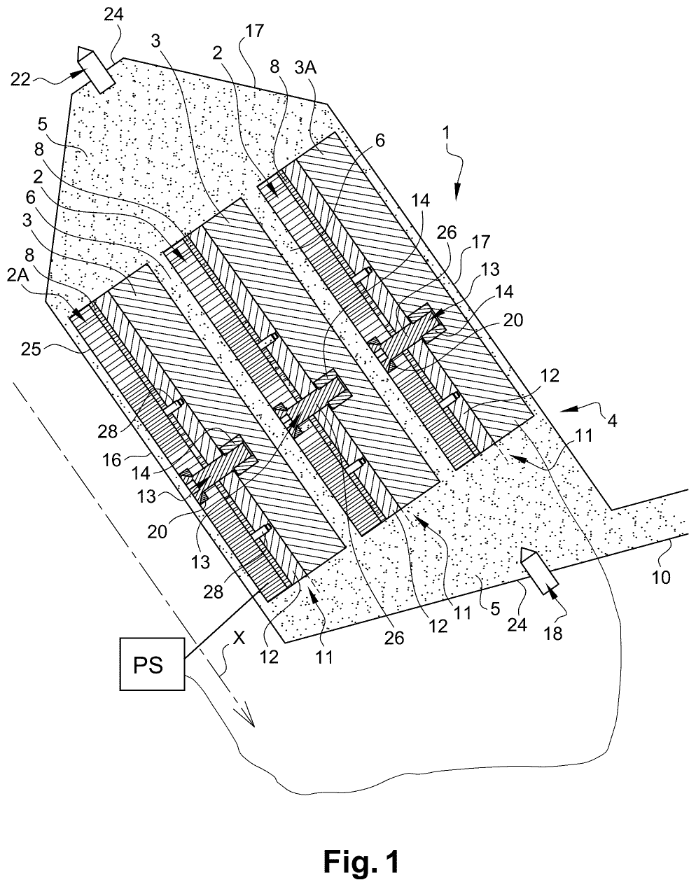

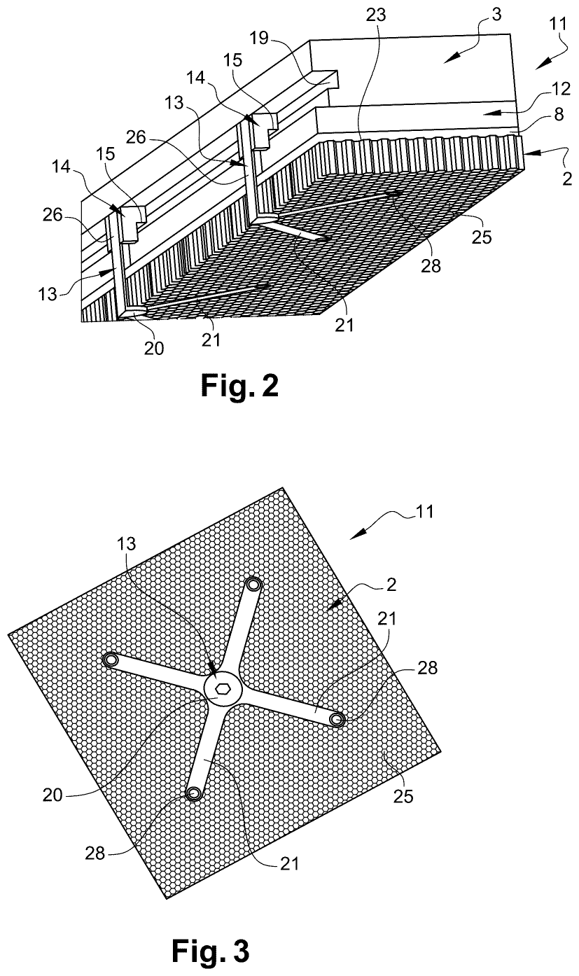

With reference to FIG. 1, the apparatus 1 comprises a casing 4 extending along a longitudinal axis X in which the electrolysis reaction occurs. Said casing 4 is delimited by a base plate 16, a cover plate 17 and two lateral plates 24.

According to the invention, the casing comprises at its first end, a terminal gas permeable anode plate 2A, which is connected to an electric power source (depicted solely schematically as PS).

Such anode plate 2 is provided with a gas recovery part 8 extending on its upper part. During the electrolysis reaction, gaseous oxygen is generated at the anode. Since these gases are electrical insulator, they prevent the good working of the electrolysis reaction and must be continuously evacuated outside of the casing 4. This is the reason why such a gas recovery part 8 is provided for. This gas recovery part 8 is a compartment provided to be filled with the electrolyte 5. Said gas recovery part 8 is thus provided to recover gases escaping through the anode plates 2.

The casing 4 also comprises, on its other end, a terminal cathode plate 3A, which is connected on the other pole of the electric power source.

Between those terminal plates, the casing also includes at least one bipolar electrode 11, facing them. Each bipolar electrode 11 comprises successively a gas permeable anode plate 2, a metallic plate 12 and a cathode plate 3. In a preferred embodiment, said metallic plate 12 is in electrical contact with the cathode plate 3 and the anode plate 2.

A gap is being maintained between the terminal anode plate 2A and the cathode plate of the bipolar plate 11, such gap forming an electrolyte chamber 6.

In the same way, a gap is maintained between the terminal cathode plate 3A and the anode plate of the bipolar plate, such gap forming also an electrolyte chamber 6.

In a preferred embodiment, a plurality of bipolar plates 11 are provided successively between the terminal anode and cathode plates. A gap is maintained between each cathode plate and each anode plate of two successive bipolar electrodes to form additional electrolyte chambers 6.

In order to produce iron metal through the electrolysis reaction, an electrolyte 5—preferably water-based solution like a sodium hydroxide aqueous solution—flows through the casing 4 inside the electrolyte chambers 6 while the apparatus 1 is operating. The gas permeable anode plates 2 are totally immersed in this electrolyte 5.

The apparatus 1 also comprises means for circulating this electrolyte within the casing 4. Iron ore is preferentially supplied into the apparatus 1 as a powder suspension within the electrolyte 5 through the inlet 18.

The casing 4 includes also a gas outlet 10 in fluidic connection with the electrolyte chambers 6. When the apparatus 1 is operating, the electrolyte 5 flowing from the gas recovery part 8 is redirected towards all the electrolyte chambers 6 thanks to gravity.

In a first embodiment, the metallic plate 12 comprises two opposite longitudinal edges extending from one surface of said metal plate. The free ends of these longitudinal edges are in contact with the anode plate 2, and the gas recovery part 8 is thus a compartment longitudinally delimited by the two opposite edges. Finally, the opposite surface of the metallic plate 12 is in contact with the anode plate 2.

In a preferred embodiment, spacers are inserted between the metallic plate 12 and the anode plate 2 in order to keep them apart and generate a space forming the gas recovery part 8 of the considered bipolar electrode 11.

The cathode plate 3, the metallic plate 12, such optional spacers and the anode plate 2 of each bipolar electrode 11 can be held together with a plurality of connecting means 13. Each connecting means 13 may comprise:
a first nut 14 having a T-section with a shoulder 15 forming a bearing stop. This bearing stop 15 is received in a longitudinal T-slot 19 managed all along the cathode plate 3;
a second nut 20 from which extends a plurality of arms 21 in contact support with the side 25 of the anode plate 2 opposite to the gas recovery part 8, and.
a rod 26 extending at least through the anode plate 2 and the metallic plate 12 which opposite ends are solidarized to the respective first 14 and second 20 nuts.

In addition, the free ends of the arms 21 extending from the considered second nut 20 are solidarized to the metallic plate 12 with pins 28 extending through the anode plate 2 and screwed in the metallic plate 12 of the considered bipolar electrode 11. Advantageously, the spacers keeping the cathode plate 3 and the anode plate 2 apart are each disposed around the considered pin 28.

In order to manufacture the apparatus 1 of the invention, each bipolar electrode 11 is first made by assembling the cathode plate 3, the metallic plate 12 and the anode plate 2 with connecting means 13.

The bipolar electrodes 11 are superimposed and assembled with fastening means, said bipolar electrodes 11 being separated from each other by a gap. The assembled bipolar electrodes 11 are thus inserted inside and solidarized to the casing 4 of the apparatus 1.

In a preferred embodiment, the apparatus 1 comprises an upper bipolar electrode 11 in front of the cover plate 17 of the casing 4, a lower bipolar electrode 11 in front of the base plate 16 of the casing 4, and intermediate bipolar electrodes 11 disposed between the upper and the lower bipolar electrodes 11 one above the other.

The cathode plate 3 of the upper bipolar electrode 11 is facing the cover plate 17 of the casing 4 while the anode plate 2 of the lower bipolar electrode 11 is facing the base plate 16 of the casing 4. The anode plate 2 of any considered intermediate bipolar electrode 11 is in front of the cathode plate 3 of the adjacent bottom bipolar electrode 11, while the cathode plate 3 of said considered intermediate bipolar electrode 11 is in front of the anode plate 22 of the adjacent above bipolar electrode 11. Finally, the gap between each bipolar electrode 11 is forming the considered electrolyte chamber 6.

The working of the apparatus 1 during the electrolysis reaction will now be described.

The electrolyte 5 is continuously circulating inside a circuit, through the electrolyte chamber 6 of each electrolytic cell from the inlet 18 to the outlet 22, thanks to an operating pump.

The electrical power source connected both to the terminal anode plate 2 and to the terminal cathode plate 3 is turned on and the electrolyte chambers 6 are regularly fed with iron ore coming from the means to supply iron ore to the apparatus 1. The casing 4 is almost filled with electrolyte 5, as depicted in FIG. 1, and only the gas outlet 10 is free of electrolyte. In these conditions the electrolysis reaction may occur.

Iron ore is reduced, and pure iron is deposited on the cathode surfaces 3 of all bipolar plates 11, while generated oxygen flows, together with the electrolyte 5, through the anode plate 2 of each bipolar plate and of the terminal anode plate, towards the gas recovery parts 8.

To allow gases circulation from the gas recovery parts 8 towards gas outlet 10, the longitudinal axis X is preferentially inclined relative to a horizontal direction following an angle comprised between 40° and 60°, preferentially 50°. The gas outlet 10 is thus in the highest position of the casing 4 to allow gases evacuation.

In the embodiment as illustrated only one gas outlet 10 is represented but one can imagine in a non-illustrated embodiment that this outlet could be a main outlet connected to secondary outlets designed to exit gases of each gas recovery part 8.

In a preferred embodiment the electrical power source uses renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced. This further limit the CO2 footprint of the iron production process.

1-6. (canceled)

7. An apparatus for the production of iron metal through reduction of iron ore by an electrolysis reaction, the electrolysis reaction generating a gas, the apparatus comprising:
a casing including successively:
a terminal gas-permeable anode plate at a first end of the casing, the anode plate being connected to a source of electric power and a gas recovery part extending along an upper part of the anode plate,
at least one bipolar electrode including successively a cathode plate, a metallic plate, a gas recovery part and a gas-permeable anode plate,
a terminal cathode plate at the other end of the casing, the terminal cathode plate being connected to the source of electric power,
a gap being maintained between said terminal anode plate and the cathode plate of the bipolar plate, the gap forming an electrolyte chamber,
a further gap being maintained between the terminal cathode plate and the anode plate of the bipolar plate, the further gap forming a further electrolyte chamber,
the casing circulating an electrolyte within the electrolyte chambers and having a supply to supply iron ore to the electrolyte chamber and further electrolytic chamber and a gas outlet in fluidic connection with the electrolyte chamber and further electrolytic chamber.

8. The apparatus as recited in claim 7 wherein the casing includes a plurality of bipolar electrodes extending successively between the terminal anode plate and the terminal cathode plate, a gap being maintained between each bipolar electrode to define a respective electrolyte chamber.

9. The apparatus as recited in claim 7 wherein the terminal anode plate and the terminal cathode plate are part of bipolar electrodes.

10. The apparatus as recited in claim 9 wherein the bipolar electrodes are held together with connectors.

11. The apparatus as recited in claim 7 wherein the terminal cathode plate and the cathode plate of the bipolar electrode are made of graphite.

12. The apparatus as recited in claim 7 wherein the source of electric power is supplied by renewable energy.
